(19) United States
(12) Patent Application Publication
(10) Pub. No.: US 2025/0355134 A1
(43) Pub. Date: Nov. 20, 2025

(54) METHODS AND SYSTEMS FOR GENERATING WEATHER FORECAST

(71) Applicant: Y.E. Hub Armenia LLC, Yerevan (AM)

(72) Inventors: Tatiana BABUKHINA, Dolgoprudny (RU); Petr VYTOVTOV, Moscow (RU); Aleksandr GANSHIN, Moscow (RU); Maksim DANILOV, Cheboksary (RU); Evgeniia ELISTRATOVA, Moscow (RU); Aleksei MARATKANOV, Krymsk (RU)

(21) Appl. No.: 19/204,423

(22) Filed: May 9, 2025

(30) Foreign Application Priority Data
May 16, 2024 (RU) 2024113215

(51) Int. Cl. G01W 1/10; G01S 13/95; G01W 1/14; G06V 10/82

(52) U.S. Cl. CPC G01W 1/10; G01S 13/95; G01W 1/14; G06V 10/82; G01W 2203/00

(57) ABSTRACT

A method of training a machine learning (ML) model is disclosed. The method includes acquiring a training set including a training input and a training label. The training input includes first user-generated input being indicative weather conditions provided from the user devices at a first timestep for the pre-determined area. The training label includes second user-generated input indicative of weather conditions provided from the user devices at the second timestep for the pre-determined area. The method comprises generating, using the ML model and the training input, a predicted output indicative of predicted weather conditions for the second timestep for the pre-determined area, generating a loss based on a comparison between the predicted output and the second user-generated input, and training the ML model using the loss.

### CROSS-REFERENCE

The present application claims priority to Russian Patent Application No. 2024113215, entitled “Methods and Systems for Generating Weather Forecast”, filed May 16, 2024, the entirety of which is incorporated herein by reference.

### FIELD OF THE TECHNOLOGY

The present technology relates to methods and systems for weather forecasting in general and, more particularly to methods and systems for generating a weather forecast using a machine learning algorithm executed by a computing device.

### BACKGROUND

Weather forecasting is widely used in a variety of situations. Weather forecasting can be split into several categories and/or types depending on the purpose. Agricultural forecasts include detailed predictions of the atmospheric precipitation; sea and river forecasts include detailed predictions of wind, waves, atmospheric phenomena, air temperature; aviation forecasts include detailed predictions of wind, visibility, atmospheric phenomena, cloudiness, air temperature, and forecasts for general consumer use include a much more general (i.e. high level) prediction in regard to the cloud cover, precipitation, atmospheric phenomena, wind, temperature, humidity, atmospheric pressure, etc.

A user can receive current weather prediction for a given territory from a variety of sources, e.g. radio stations, television, the Internet, weather apps; just to name a few. At the same time, the accuracy of the current weather parameters can be considered to be reliable enough as it is based on the real data received from the weather stations. The accuracy of the current weather parameters depends on the accuracy of equipment of the data provider. At present, the world meteorological organization (WMO) collects meteorological, climatological, hydrological as well as marine and oceanographic data around the world via more than 15 satellites, 100 anchored buoys, 600 drifting buoys, 3,000 aircrafts, 7,300 ships and around 10,000 ground stations. Member countries of the WMO have access to this data.

The user can also get data representative of forecasted weather parameters for a given moment in time in the future (the given moment in the future, after the current moment of time) for a given territory from either the same and/or other sources. However, the accuracy of the forecast parameters depends on the time of the forecast (i.e. how far in advance the forecast is being executed), the forecast method, the given territory and many other criteria. For example, depending on the time of the forecast vis-a-vis the time in the future for which the forecast is being generated, the forecast can be categorized as: a very-short-range forecast—up to 12 hours; a short-range forecast—from 12 to 36 hours; a mid-range forecast—from 36 hours to 10 days; a long-range forecast—from 10 days to a season (3 months); and a very-long-range forecast—more than 3 months (a year, a few years). The accuracy of the forecasts generally decreases with the increase of time between the time when the forecast is generated and the time for which the forecast is generated. As an example, the accuracy (reliability) of the very-short-range forecast can be 95-96%, the short-range forecast—85-95%, the mid-range forecast—65-80%, the long-range forecast—60-65%, and the very-long-range forecast—not more than 50%.

The accuracy also depends on the forecasting methods used for generating the forecast. At the moment, the numerical models of weather forecasting are generally considered to be the most accurate and the most reliable of all the known forecasting methods. Put another way, forecasting methods implemented by computational systems for weather forecasting using current weather parameters data. These computational systems can use raw data provided by weather balloons, weather satellites, and ground weather stations.

Furthermore, even in the modern world, activities of individuals depend on weather conditions outside their homes. Plans and activities of the significant part of the population are influenced by temperature and precipitation. Like ancient people used the environmental conditions to plan their hunt, modern people plan their everyday activities considering the probability of rain, cloudiness, and other elements potentially affecting such activities.

Various weather forecast services address this need and provide major weather parameters, such as temperature, intensity and type of precipitation, cloudiness, humidity, pressure, wind direction and speed. These services include the information on the current weather conditions, operational prediction up to 2 hours, which is called “nowcasting”, medium-range forecasts up to 10 days, and extended range weather prediction for several months. Yandex. Weather is a major weather forecasting provider in Russia, with approximately 5M daily active users and the monthly audience exceeding 24M unique cross-device users as estimated by Yandex.Radar in December 2018.

U.S. Pat. No. 11,551,156-B2, issued on Jan. 10, 2023, assigned to HRL Laboratories LLC, and entitled “SYSTEMS AND METHODS FOR FORECAST ALERTS WITH PROGRAMMABLE HUMAN-MACHINE HYBRID ENSEMBLE LEARNING,” discloses a method for computing a human-machine hybrid ensemble prediction that includes: receiving an individual forecasting question (IFP); classifying the IFP into one of a plurality of canonical question topics; identifying machine models associated with the canonical question topic. Further, for each of the machine models, the method includes: receiving, from one of a plurality of human participants: a first task input including a selection of sets of training data; a second task input including selections of portions of the selected sets of training data; and a third task input including model parameters to configure the machine model; training the machine model in accordance with the first, second, and third task inputs; and computing a machine model forecast based on the trained machine model; computing an aggregated forecast from machine model forecasts computed by the machine models; and sending an alert in response to determining that the aggregated forecast satisfies a threshold condition.

### SUMMARY

The present technology may overcome at least some drawbacks associated with known weather forecasting solutions.

For example, radar-based precipitation models are constrained by radar locations and thus poorly scalable. The radars themselves are expensive, their installation depends on agreements with local government and populace, and their operation requires trained service personnel. Taking an example of Russia, the coverage is particularly poor due to the large size of the country, and highly non-uniform population distribution, with many remote regions lacking the infrastructure to operate the radar facility. Similar problems arise for many developing countries with a large population in need of weather services, but no infrastructure to support radar networks.

One of the technical challenges with the prior art approaches is dependability on large amounts of radar data for making predictions. Albeit being accurate, radar data may not be available in large amounts and/or may not be uniformly available for all territories to be covered.

For example, some meteorological radars can cover 200-250 kilometers horizontally but are often installed within highly populated cities and do not cover territory of low populated towns. Using an example of Russia, only about 40% of inhabited territories of Russian is covered by meteorological radars. Another issue with meteorological radars is blind zones stemming from meteorological radars' detection. One will appreciate that radar maps have so called “blind zones”-sectors unavailable for scanning by radar because of surrounding buildings or other non-transparent for radio waves obstacles. Thus, non-limiting embodiments of the present technology aim to address at least some of the above technical problems by methods that highly rely on meteorological radars data and satellite data.

In some embodiments of the present technology, there is provided a system configured to enable nowcasting services. The system is configured may be configured to collect and make use of user-provided information referred to as “user-generated content” (UGC) data.

In one example, the system may trigger a user device executing a weather application associated with the nowcasting service to display a prompt for the user to indicate whether or not it is currently raining at the current location of the user device. Data associated with such user interaction may be collected and provided as UGC data to the system. In other words, an aggregated explicit user feedback may be collected by the system for generating forecasting predictions.

Developers of the present technology have realized at least some advantages associated with employing both the UGC data and sensor data for making forecasting predictions. In some embodiments, there is provided a system configured to execute one or more machine learning algorithms (MLAs) where UGC data has been used as a prediction target during the training phase thereof. For example, the prediction target may be a probability of precipitation over a given geographical region.

In some embodiments, the system may be configured to train a Convolutional Neural Network (CNN) based on historical weather condition data indicative of snow, fog, rain, temperature, pressure, etc. over a corresponding region such as a map section (e.g., covering an area of 1 square kilometer). Additionally, or alternatively, the system may be configured to select a map section of a pre-determined size and retrieve the corresponding historical sensor data associated with the map section.

It is contemplated that the CNN can receive as input the corresponding historical weather sensor data and the corresponding UGC data for a given map section and a given time interval. The CNN can receive a corresponding label indicative of historic UGC data for the given map section at a given time stamp. The CNN is trained, based on the sensor data inputs and the UGC data inputs, to predict most likely UGC data for the given time stamp. The given time stamp is at a future moment in time after the given time interval associated with the sensor data inputs and the UGC data inputs. In some embodiments of the present technology, the predicted UGC data can be used in lieu or in addition to actual UGC provided by users.

In one example, let it be assumed that the CNN is trained to predict precipitation probability for a given map section. The training input may comprise sensor data and UGC data for that given map section for a time interval of 10 am to 11 am of a given day. The CNN is being trained to predict the UGC data for the given map section for a time stamp of 12 pm on the given day, for example. The UGC data may be indicative of user feedback regarding precipitation for the given map section at 12 pm for that given day. In this example, during the inference step, the trained CNN may acquire current weather sensor data and current UGC data for a given map section, and predict a future UGC data for that given map section a future moment in time.

In other embodiments, the CNN may acquire a training input for a 40 min interval. It is contemplated that sequential inputs may be provided to the CNN with a 10 min time step (e.g. every 10 min, a data batch for the latest 40 min may be provided). It is contemplated that in these embodiments, the CNN may be configured to predict UGC data for a next 2-hour interval. For example, based on a previous 40 min of sensor data and UGC data, the CNN may predict future UGC data for the next 2 hours. The CNN may be configured to predict sequential future UGC data with a 10 min time step (e.g., every 10 min, the CNN may predict the next 2 hours of UGC data).

It should be noted that the output of the CNN may be used in combination with one or more other predictions and/or weather data generated by the system for providing weather forecast to users of the system.

In a first broad aspect of the present technology, there is provided a method of training a machine learning (ML) model for generating predicted weather conditions. The method is executable by a processor. The processor is communicatively coupled with meteorological sources, referred to herein as meteo-sources, and user devices. The method comprises, during a given training iteration, acquiring a training set including a training input and a training label. The training input includes a meteorological input and a first user-generated input. The meteorological input is indicative of weather conditions measured by the meteo-sources for a second timestep for a pre-determined area. The first user-generated input is indicative weather conditions provided from the user devices at a first timestep for the pre-determined area. The first timestep temporally precedes the second timestep. The training label includes second user-generated input indicative of weather conditions provided from the user devices at the second timestep for the pre-determined area. The method comprises, during a given training iteration, generating, using the ML model and the training input, a predicted output indicative of predicted weather conditions for the second timestep for the pre-determined area. The method comprises, during a given training iteration, generating a loss based on a comparison between the predicted output and the second user-generated input. The method comprises, during a given training iteration, training the ML model using the loss. The method comprises, during a given in-use iteration of the ML model, acquiring an in-use input including an in-use meteorological input and an in-use user-generated input for a third timestep for the pre-determined area. The method comprises, during a given in-use iteration of the ML model, generating, a second predicted output using the ML model and the in-use input. The second predicted output is indicative of predicted weather conditions for a fourth timestep for the pre-determined area, the third timestep temporally preceding the fourth timestep.

In some embodiments of the method, the ML model is an Image-to-Image Convolutional Neural Network (I2ICNN).

In some embodiments of the method, the loss is a first loss, and the method further comprises generating a second loss based on a comparison of an intermediary output of the I2ICNN with a radar input. The radar input is indicative of weather conditions measured by a radar source for the second timestep for the pre-determined area. The training the ML model comprises training the ML model using a combination of the first loss and the second loss.

In some embodiments of the method, the ML model comprises a first ML model and a second ML model, and the generating the predicted output includes generating an intermediary output using the first ML model and the training input. The intermediary output is indicative of predicted weather conditions for the second timestep for the pre-determined area. The intermediary output includes an intermediary output image and a first mask. The first mask is indicative of a likelihood of precipitation for corresponding pixels of the intermediary output image. The method further comprises generating the predicted output using the second ML model, the training input and the intermediary output. The predicted output includes an output image and a binary mask, and the binary mask is indicative of whether or not the precipitation is present for corresponding pixels of the output image.

In some embodiments of the method, the loss is a first loss, and the method further comprises generating a second loss based on a comparison between the intermediary output and a radar input for the second time step for the pre-determined area. The radar input is indicative of weather conditions measured by a radar source for the second timestep for the pre-determined area. The training the ML model comprises training the first ML model using the second loss, and training the second ML model using the first loss.

In some embodiments of the method, the first ML model is a UNet-based model, and the second ML model is a Catboost-based model.

In some embodiments of the method, the method further comprises acquiring a second in-use input including a second in-use meteorological input and a second predicted output generated by the ML model, and generating a third predicted output using the ML model and the second in-use input. The third predicted output is indicative of predicted weather conditions for a fifth timestep for the pre-determined area, the fourth timestep temporally preceding the fifth future timestep.

In some embodiments of the method, the method further comprises providing, to a nowcasting ML model, a nowcasting training input for the fourth timestep for the pre-determined area, the nowcasting input including the second predicted output from the ML model. The method further comprises generating, by the nowcasting ML model using the nowcasting training input, a nowcasting output indicative of predicted weather conditions for the fifth timestep for the pre-determined area. The method further comprises generating a nowcasting loss based on a comparison between the nowcasting output for the fifth timestep and the third predicted output from the ML model for the fifth timestep. The method further comprises training the nowcasting ML model using the nowcasting loss.

In some embodiments of the method, the nowcasting input further includes a radar input indicative of weather conditions measured by a radar source for the fourth timestep for the pre-determined area, and a third user-generated input for the fourth timestep.

In some embodiments of the method, the nowcasting ML model is at least one of a LSTM-based model and a Transformer-based model.

In a second broad aspect of the present technology, there is provided a method of training a nowcasting machine learning (ML) model for generating predicted weather conditions. The method is executable by a processor. The method comprises generating a series of predicted outputs using a first ML model. A given one from the series of predicted outputs is indicative of predicted user-generated data for a corresponding timestep for the pre-determined area. The method comprises during a first training iteration, generating a training set using the series of predicted outputs for the nowcasting ML model. The training set includes a training input and a training label. The training input has the given one from the series of predicted outputs. The training label has a next one from the series of predicted outputs, the next one from the series of predicted outputs being indicative of predicted user-generated data for a next timestep for the pre-determined area, the corresponding timestep temporally proceeding the next timestep. The method comprises during the first training iteration, training the nowcasting ML model using the training set. The method comprises during a second training iteration, generating a second training set using the series of predicted outputs for the nowcasting ML model, the training set including a second training input and a second training label. The second training input has the next one from the series of predicted outputs. The training label has an additional one from the series of predicted outputs. The additional one from the series of predicted outputs is indicative of predicted user-generated data for an additional timestep for the pre-determined area, the next timestep temporally proceeding the additional timestep. The method comprises during a second training iteration, training the nowcasting ML model using the second training set.

In a third broad aspect of the present technology, there is provided a processor for training a machine learning (ML) model for generating predicted weather conditions, the processor being communicatively coupled with meteo-sources and user devices. The processor is configured to, during a given training iteration, acquire a training set including a training input and a training label. The training input includes a meteorological input and a first user-generated input. The meteorological input is indicative of weather conditions measured by the meteo-sources for a second timestep for a pre-determined area. The first user-generated input is indicative weather conditions provided from the user devices at a first timestep for the pre-determined area, the first timestep temporally preceding the second timestep. The training label includes second user-generated input indicative of weather conditions provided from the user devices at the second timestep for the pre-determined area. The processor is configured to, during a given training iteration, generate, using the ML model and the training input, a predicted output indicative of predicted weather conditions for the second timestep for the pre-determined area. The processor is configured to, during a given training iteration, generate a loss based on a comparison between the predicted output and the second user-generated input. The processor is configured to, during a given training iteration, train the ML model using the loss. The processor is configured to, during a given in-use iteration of the ML model, acquire an in-use input including an in-use meteorological input and an in-use user-generated input for a third timestep for the pre-determined area. The processor is configured to, during a given in-use iteration of the ML model, generate, a second predicted output using the ML model and the in-use input. The second predicted output is indicative of predicted weather conditions for a fourth timestep for the pre-determined area, the third timestep temporally preceding the fourth timestep.

In some embodiments of the processor, the ML model is an Image-to-Image Convolutional Neural Network (I2ICNN).

In some embodiments of the processor, the loss is a first loss, the processor being further configured to: generate a second loss based on a comparison of an intermediary output of the I2ICNN with a radar input, the radar input being indicative of weather conditions measured by a radar source for the second timestep for the pre-determined area. To train the ML model the processor is configured to train the ML model using a combination of the first loss and the second loss.

In some embodiments of the processor, the ML model comprises a first ML model and a second ML model, to generate the predicted output including the processor configured to generate an intermediary output using the first ML model and the training input, the intermediary output indicative of predicted weather conditions for the second timestep for the pre-determined area. The intermediary output including an intermediary output image and a first mask, the first mask being indicative of a likelihood of precipitation for corresponding pixels of the intermediary output image. The processor is configured to generate the predicted output using the second ML model, the training input and the intermediary output. The predicted output includes an output image and a binary mask, the binary mask being indicative of whether or not the precipitation is present for corresponding pixels of the output image.

In some embodiments of the processor, the loss is a first loss, and wherein the processor is further configured to generate a second loss based on a comparison between the intermediary output and a radar input for the second time step for the pre-determined area, the radar input being indicative of weather conditions measured by a radar source for the second timestep for the pre-determined area. The processor configured to train the ML model comprises the processor configured to train the first ML model using the second loss, and train the second ML model using the first loss.

In some embodiments of the processor, the first ML model is a UNet-based model, and the second ML model is a Catboost-based model.

In some embodiments of the processor, the processor is further configured to acquire a second in-use input including a second in-use meteorological input and a second predicted output generated by the ML model, and generate a third predicted output using the ML model and the second in-use input. The third predicted output being indicative of predicted weather conditions for a fifth timestep for the pre-determined area, the fourth timestep temporally preceding the fifth future timestep.

In some embodiments of the processor, the processor is further configured to provide, to a nowcasting ML model, a nowcasting training input for the fourth timestep for the pre-determined area, the nowcasting input including the second predicted output from the ML model; generate, by the nowcasting ML model using the nowcasting training input, a nowcasting output indicative of predicted weather conditions for the fifth timestep for the pre-determined area; generate a nowcasting loss based on a comparison between the nowcasting output for the fifth timestep and the third predicted output from the ML model for the fifth timestep; and train the nowcasting ML model using the nowcasting loss.

In the context of the present specification, a “server” is a computer program that is running on appropriate hardware and is capable of receiving requests (e.g. from electronic devices) over the network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both cases are included within the expression “at least one server”.

In the context of the present specification, “electronic device” (or “computer device”) is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

In this context, terms a “first”, a “second”, a “third”, etc. were used as ordinal numbers only to show the difference between these nouns and not to describe any particular type of relationship between them.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (descriptions, advertisements, messages, etc.), documents, spreadsheets, etc.

In the context of the present specification, unless expressly provided otherwise, an “indication” to a digital object can the digital object itself or a pointer, reference, link, or other indirect mechanism enabling the recipient of the indication to locate a network, memory, database, or other computer-readable medium location from which the digital object may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of a digital object will take the form of a database key for an entry in a particular table of a predetermined database containing the digital object, then the sending of the database key is all that is required to effectively convey the digital object to the recipient, even though the digital object itself was not transmitted as between the sender and the recipient of the indication.

In the context of the present specification, an “object location” is a location of a geographical object, namely, a specific region, city, area, airport, railroad station, etc. Specific geographical coordinates, for example, geolocation data, which can be received by a server from an electronic device via a communication network, can also be used as an object location.

In the context of the present specification, the expression “data storage” is intended to include media of any nature and kind whatsoever, including RAM, ROM, disks (CD-ROMs, DVDs, floppy disks, hard drivers, etc.), USB keys, solid state-drives, tape drives, etc.

Implementations of the present technology each have at least one of the above-mentioned object and/or aspects.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram illustrating a system, the system being implemented in accordance with non-limiting embodiments of the present technology.

FIG. 2 is a schematic representation of a training pipeline of a Machine Learning Algorithm (MLA) executed by the system of FIG. 1 for precipitation predictions in accordance with at least some embodiments of the present technology.

FIG. 3 is a schematic representation of an other training pipeline of the MLA executed by the system of FIG. 1 for precipitation predictions for n upcoming hours in accordance with at least some embodiments of the present technology.

FIG. 4 is a scheme-block illustration of a method executable by a processor of the system of FIG. 1 in accordance with at least some embodiments of the present technology.

### DETAILED DESCRIPTION

The examples and conditional language recited herein are principally intended to aid the reader in understanding the principles of the present technology and not to limit its scope to such specifically recited examples and conditions.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

### Computer System

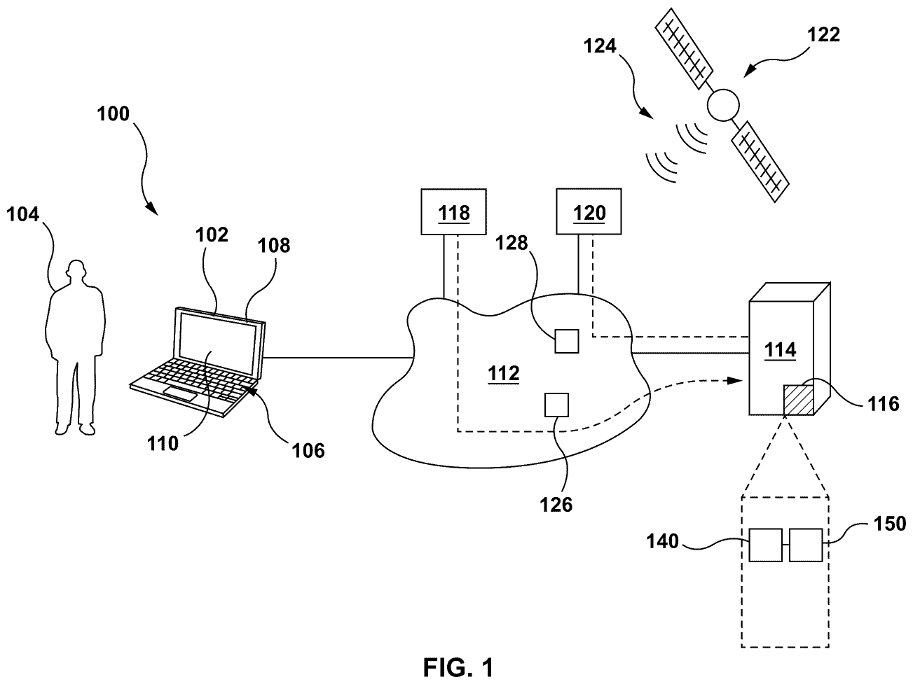

FIG. 1 depicts a schematic diagram of a computer system 100. It is to be expressly understood that the computer system 100 is merely one possible implementation of the present technology. In some cases, what are believed to be helpful examples of modifications to the computer system 100 may also be set forth below. This description is not intended to define the scope or set forth the bounds of the present technology. In some cases, what are believed to be helpful examples of modifications to computer system 100 may also be set forth below. This is done merely as an aid to understanding, and, again, not to define the scope or set forth the bounds of the present technology. These modifications are not an exhaustive list, and, as a person skilled in the art would understand, other modifications are likely possible. In addition it is to be understood that the computer system 100 may provide in certain instances simple implementations of the present technology, and that where such is the case they have been presented in this manner as an aid to understanding. As persons skilled in the art would understand, various implementations of the present technology may be of a greater complexity.

The computer system 100 comprises an electronic device 102. The electronic device 102 is associated with a user 104 and, as such, can sometimes be referred to as a “client device”. It should be noted that the fact that the electronic device 102 is associated with the user 104 does not mean to suggest or imply any mode of operation-such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 102 comprises a permanent storage 106. The permanent storage 106 may encompass one or more storage media and generally provides a place to store computer-executable instructions executable by a processor 108. By way of an example, the permanent storage 106 may be implemented as a computer-readable storage medium including Read-Only Memory (ROM), hard disk drives (HDDs), solid-state drives (SSDs), and flash-memory cards.

The electronic device 102 comprises hardware and/or software and/or firmware (or a combination thereof) to execute a weather application 110. Generally speaking, the weather application 110 is capable of hands-free activation in response to one or more “hot words”, and able to perform tasks or services in response to a command received by the user 104. For example, the weather application 110 may be implemented as an YANDEX.WEATHER application (provided by Yandex LLC of Lev Tolstoy Street, No. 16, Moscow, 119021, Russia). Alternatively, the weather application 110 can be implemented as a browser application, with the user 104 accessing a weather portal or another weather service to obtain a weather prediction. For example, the weather portal can be associated with a news agency, or another provider of weather forecasting services. Alternatively or additionally, the weather application 110 can be a “native application” for the electronic device. For example, in those embodiments of the present technology, where the electronic device 102 is implemented as a smart phone, such as for example APPLE branded smart phone, the weather application 110 can be implemented as WEATHER app provided by the operating system (i.e. iOS) of the electronic device 102.

The electronic device 102 is coupled, via a communication network 112, to a server 114.

The server 114 may be implemented as a conventional computer server. In an example of an embodiment of the present technology, the server 114 may be implemented as a Dell™ PowerEdge™ Server running the Microsoft™ Windows Server™ operating system. Needless to say, the server 114 may be implemented in any other suitable hardware and/or software and/or firmware or a combination thereof. In this non-limiting embodiment of the present technology, the server 114 is implemented as a single server. In alternative non-limiting embodiments of the present technology, the functionality of the server 114 may be distributed and may be implemented via multiple servers.

The implementation of the server 114 is well known. However, briefly speaking, the server 114 comprises a communication interface (not depicted) structured and configured to communicate with various entities via the communication network 112. The server 114 also comprises at least one processor 116 operationally connected with the communication interface structured and configured to execute various processes that will be described herein.

Also communicatively coupled to the communication network 112 is a meteorological data source 118 and a satellite data source 120.

Broadly speaking, the meteorological data source 118 is configured to transmit to the server 114, an indication of meteorological radar data 126 for a given geographical region. In accordance with the non-limiting embodiments of the present technology, the meteorological radar data 126 can be represented as a pre-determined number of sequential 3D precipitation maps having been captured before the given period of time. The pre-determined number of sequential 3D precipitation maps can be six.

In some embodiments, a sensor data provider may provide, in addition to or instead of 3D precipitation maps, 2D image data with precipitation intensity values and/or radar reflectivity values, without departing from the scope of the present technology.

The meteorological data source 118 can generate the meteorological radar data 126 based on a reading of a meteorological radar (not depicted). As has been alluded to above, the meteorological data source 118 can receive the data from the meteorological radar, which has generated the meteorological data using a meteorological radar analysis that is based on the Doppler effect. The meteorological radar sends radio waves every 10 minutes, the radio waves get reflected by the environment, including large water drops and the so-reflected wave, in a form of a radio waves response, returns back to the meteorological radar. Radio waves response is a reflection and a radial speed data associated therewith represents information about environment including location of water drops and its density. Based on the radio waves response, the meteorological radar forms 3-dimensional (3D) precipitation map that represents atmosphere in 200-250 kilometers horizontally and 10 kilometers vertically.

3D precipitation map depicts areas with large drops of water (larger than 50 micrometers) marked on it. Saturation and color are used to represent density of water drops. The more saturated the color, the higher probability of precipitation. On the 3D precipitation map each pixel of the image represents 2×2 kilometers of actual landscape. In other words, the 3D precipitation map allows predicting the precipitation with up to 2×2 kilometers precision.

It should be noted that meteorological radar data 126 may be provided in different formats depending on inter alia settings of the metho data source 118. For example, some radars may scan and provide data with a resolution of 1×1 km. In another example, other radars can perform scans and provide data every 2 min. Other scanning frequencies and radar data provision frequencies may be every 5 min, 10 min, 15 min, and the like. In a further example, radars can scan and provided data with a step of up to 500 m.

The satellite data source 120 is configured to transmit to the server 114 an indication of satellite data 128 for the given geographical region. The satellite data source 120 generates the satellite data 128 based on signals 124 received from a satellite 122.

In some embodiments of the present technology, the satellite 122 can be a geo-stationary satellite. As has been alluded to above, the satellite 122 can be a satellite is moving around the Earth at its respective speed such that its own location relative to the Earth is not changing (i.e. the satellite has a stationary orbit). Such satellites are typically positioned over the 41^{st}-degree longitude over the Indian Ocean. However, satellite positioning may vary depending on inter alia various implementations of the present technology.

The satellite 122 can be configured to capture a photo every 15 minutes, for example. Each photo may include information from 12 channels: 11 channels in visible and infrared diapasons within resolution of 3×3 kilometers and 1 visible channel with a 1×1 kilometers resolution. It should be understood that the satellite 122 can be configured to take photos at a different capturing frequency, as we all with different content and/or different breakdown of channels and/or a different number of the channels. As an example, each photo has resolution 3712×3712 pixels or 14 megapixels. However, it should be noted that type and format of satellite data acquired by the processor 116 may depend on inter alia a specific satellite 122 without departing from the scope of the present technology.

In a specific non-limiting embodiment of the present technology, the satellite 122 can be implemented as the Meteosat-8 satellite can be used. Naturally, other satellites can be used as a source for the satellite data 128. In other embodiments, the satellite 122 may be a different satellite form the Meteosat series, which include geostationary meteorological satellites operated under the Meteosat Transition Program (MTP), the Meteosat Second Generation (MSG) program, Geostationary Operational Environmental Satellite (GOES and Himawari (Meteorological Satellite Center (MSC)).

One (or more) of the meteorological data source 118, the satellite data source 120, and the server 114 can receive an indication of the additional information. More specifically, one (or more) of the meteorological data source 118, the satellite data source 120, and the server 114 can receive the indication information can be data from Global Forecast System (GFS). The data can be implanted as a weather prediction for the given geographical region. The Global Forecast System (GFS) is a global numerical weather prediction system containing a global computer model and variation analysis run by the United States' National Weather Service (NWS).

Additionally, one or more of the meteorological data source 118, the satellite data source 120, and the server 114 can receive or generate an indication of the calculations of the sun location relative to the horizon.

Additionally, one or more of the meteorological data source 118, the satellite data source 120, and the server 114 can receive or generate an indication of information about landscape associated with the given geographical region can be obtained.

It is noted that even though the meteorological data source 118 and the satellite data source 120 are depicted as separate entities from each other, they can be implemented as a single entity. Furthermore, the meteorological data source 118 and the satellite data source 120 can be implemented as a single entity with the server 114.

### Machine Learning Algorithms

The processor 116 of the server 114 is configured to execute a plurality of Machine Learning Algorithms (MLAs), including an MLA 140 and an MLA 150. It should be noted that the a given MLA may be a distributed model, i.e. can be implemented in several processes executed by one or more computing devices, including the server 114, as well as other servers potentially present within the architecture of the computer system 100. A given MLA can be implemented as a Neural Network (NN). Generally speaking, a given NN consists of a group of interconnected artificial “neurons”, which process information using a connectionist approach to computation.

NNs are used to model complex relationships between inputs and outputs (without actually knowing the relationships) or to find patterns in data. NNs are first conditioned in a training phase in which they are provided with a known set of “inputs” and information for adapting the NN to generate appropriate outputs (for a given situation that is being attempted to be modelled). During this training phase, the given NN adapts to the situation being learned and changes its structure such that the given NN will be able to provide reasonable predicted outputs for given inputs in a new situation (based on what was learned). Thus, rather than trying to determine complex statistical arrangements or mathematical algorithms for a given situation; the given NN tries to provide an “intuitive” answer based on a “feeling” for a situation.

In some embodiments of the present technology the processor 116 may be configured to execute the plurality of MLAs for weather forecasting purposes. Broadly, weather forecasting using machine learning involves the application of artificial intelligence techniques to improve the accuracy and precision of weather predictions. In a first example, a given MLA may be a data-driven model that analyzes vast amounts of historical weather data, including temperature, humidity, wind patterns, and more. These models can identify complex relationships within the data that traditional physics-based models might miss. In a second example, the given MLA may be a pattern recognition model configured to recognize patterns and trends in weather data. They can identify recurring weather patterns and use them to make short-term and/or long-term forecasts. In a third example, the given MLA may be used for “nowcasting”, which is a prediction of very short-term weather conditions, often up to a few hours in advance. Machine learning is used to analyze radar and satellite imagery to provide highly localized and real-time forecasts for phenomena like thunderstorms and precipitation. In a fourth example, the given MLA may be used to downscale coarser global or regional model outputs to provide high-resolution, localized weather forecasts. Downscaling models may be used for urban planning, agriculture, and other applications requiring fine-grained weather information. In a fifth example, the given MLA may be used as part of an ensemble of forecasting systems, combining various weather models and observations to provide a range of possible outcomes and quantify forecast uncertainty.

In some embodiments of the present technology, a given MLA model may be implemented as an “image-to-image” (I2I) model, referring to a class of machine learning models designed for the transformation of images from one domain to another. A given I2I model may have a Convolutional Neural Network (CNN) architecture that is trained to learn a mapping between input and output images (sometimes in a form of tensors). These networks can be trained on pairs of images where the input image belongs to one domain, and the corresponding output image belongs to the target domain. The learning process involves optimizing the I2I model parameters to minimize the difference between the predicted and ground-truth output images.

In some embodiments, the processor 116 may provide an I2I model with input data in a form of image tensors, often acquired from satellites or other remote sensing devices, capturing the current state of a geographical region. The I2I model may generate output image tensors that represent predicted weather conditions for a specific time in the future over the geographical region. The processor 116 may train the I2I models using a supervised learning technique, where the I2I model is trained on pairs of input-output images. In some cases, the input images may represent historical or real-time observations, while the output images are corresponding ground-truth representations of future weather conditions. I2I models can be configured to acquire multi-modal data and thereby integrate information from multiple sources, including satellite imagery, radar data, and other meteorological data, to enhance the predictive capabilities of the I2I model. It is contemplated that the I2I model may take into account temporal evolution of weather patterns by processing sequences of input images to predict how weather conditions are likely to change over time.

In other embodiments, a given MLA may have a similar architecture to a model disclosed in an article entitled “U-Net: Convolutional Networks for Biomedical Image Segmentation”, authored by Olaf Ronneberger et al., published on May 18, 2015, the contents of which is incorporated herein by reference in its entirety.

In further embodiments of the present technology, a given MLA may have a similar architecture to a model disclosed in an article entitled “Convolutional LSTM Network: A Machine Learning Approach for Precipitation Nowcasting”, authored by Xingjian Shi et al., published in 2015, the contents of which is incorporated herein by reference in its entirety.

In yet another embodiment, a given MLA may be a “CatBoost” model. A Catboost model may be trained by applying gradient boosting techniques on decision trees and thereby constructs an ensemble of decision trees in order to correct errors of previous trees. In some embodiments, a given MLA may have a similar architecture to a model disclosed in an article entitled “CatBoost: unbiased boosting with categorical features”, authored by Liudmila Prokhorenkova et al., published on 20 Jan. 2019, the contents of which is incorporated herein by reference in its entirety.

In further embodiments, a given MLA may be implemented as a Recurrent Neural Networks (RNN) configured for sequential data processing. Unlike feedforward networks, RNNs have cyclic connections that enable them to maintain a hidden state, allowing information to persist across different time steps. This makes RNNs well-suited for tasks involving sequences, such as time series analysis, natural language processing, and speech recognition. RNNs can be also classified into different groups based on specific RNN architectures. For example, variant such as Long Short-Term Memory (LSTM) networks and Gated Recurrent Unit (GRU) networks can be used depending on inter alia different implementations of the present technology.

In some embodiments of the present technology, a given MLA may have a similar architecture to a model disclosed in an article entitled “Convolutional LSTM Network: A Machine Learning Approach for Precipitation Nowcasting”, authored by Xingjian Shi et al., published in 2015, the contents of which is incorporated herein by reference in its entirety.

In further embodiments, a given MLA may be implemented as a Transformer model. Unlike RNNs, a transformer architecture employs self-attention mechanisms to process input sequences in parallel, allowing them to efficiently capture long-range dependencies. The key components of transformer models include self-attention mechanisms, multi-head attention, positional encoding, feedforward neural networks, and layer normalization with residual connections.

In some embodiments of the present technology, a given MLA may have a similar architecture to a model disclosed in an article entitled “Attention Is All You Need”, authored by Ashish Vaswani et al., published in 2017, the contents of which is incorporated herein by reference in its entirety.

### UGC Prediction

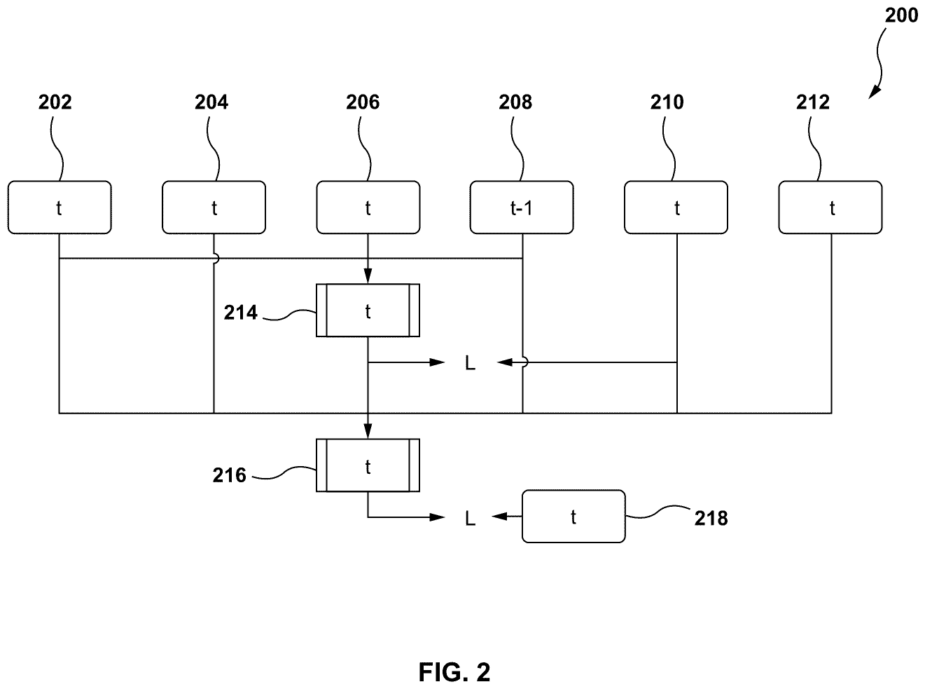

With reference to FIG. 2, there is depicted a schematic representation of a data flow used by the processor 116 during a training phase of a detection model 214 and a superfact model 216 for precipitation predictions.

As seen in FIG. 2, the processor 116 may be configured to acquire satellite data 202 for time t, Global Forecast System (GFS) data 204 for time t, radar data 210 for time t, European Centre for Medium-Range Weather Forecasts (ECMWF) data 212 for time t, and/or additional data 206 (e.g., stationary features) at time t. The processor 116 may also be configured to acquire user report data 208 for time t−1, which precedes time t.

It should be noted that ECMWF data refers to meteorological and atmospheric information generated and provided by the ECMWF. This data encompasses a wide range of parameters and variables related to the Earth's atmosphere and is derived from the center's numerical weather prediction models and assimilation systems. It should be noted that GFS data refers to meteorological and atmospheric information produced by the GFS model, which is a numerical weather prediction model run by the National Centers for Environmental Prediction (NCEP).

The detection model 214 may be configured to receive an input based on a combination of the satellite data 202 for time t, GFS data 204 for time t, the additional data 206 (e.g., stationary features) at time t, and user report data 208 for time t−1. It is contemplated that the detection model 214 may receive as input an image of size H×W×C_1, where H and W are the height and width, respectively, of a selected geographical area, and C is a number of channels corresponding to a set of pre-determined features for the detection model 214. The detection model 214 may generate an output image of size H×W with a precipitation field. For example, the output image may be associated with a pixel-by-pixel mask and indicative of a likelihood of precipitation for the corresponding pixels of the output image.

In some embodiments, the detection model 214 may be configured to generate predicted detection data for time t representative of a predicted precipitation mask over an image of a geographical area. The processor 116 may be configured to generate a first loss value based on a comparison of the predicted detection data for time t and the radar data 210 for time t. In other words, the radar data 210 for time t may be used to generate a ground-truth precipitation mask of an image of the geographical region.

The superfact model 216 may be configured to receive an input based on a combination of the satellite data 202 for time t, the GFS data 204 for time t, the additional data 206 (e.g., stationary features) at time t, the user report data 208 for time t−1, the radar data 210 for time t, the ECMWF data 212 for time t, and the detection data generated by the detection model 214. The superfact model 216 may be configured to generate superfact data indicative of a pixel-by-pixel mask and indicative of binary representation of precipitation for the corresponding pixels. It can be said that, as opposed to the detection data generated by the detection model 214, which is a comparatively rough precipitation prediction, the superfact data generated by the superfact model 216 is a refined and binary representation of whether precipitation occurs over sub-regions of the geographical area covered by the respective pixels.

In some embodiments, the superfact model 214 may be configured to generate superfact data 216 for time t representative of predicted user report data for time t. The processor 116 may be configured to generate a second loss value based on a comparison of the superfact data for time t and ground-truth user report data 218 for time t.

However, in at least some embodiments of the present technology, functionalities of the detection model 214 and the superfact model 216 may be integrated into a single model, such as the MLA 140, for example. This means that in some embodiments of the present technology, the processor 140 may be configured to execute a single model, the MLA 140, instead of two separate models 214 and 216. In these embodiments, the output of the MLA 140 may be similar to the output of the superfact model 216, without departing from the scope of the present technology.

In some embodiments, during a given training iteration, the processor 116 may input the MLA 140 with different types of data comprising: satellite data, radar data, ECMWF data and GFS data, user report data, as well as stationary features such as orography, solar angle, for example. In response, the MLA 140 may be configured to generate superfact data representative of user report data prediction. In some embodiments, the MLA 140 may be trained based on a combination of a first loss function using ground-truth radar data and a second loss function using ground-truth UGC data.

As such, in some embodiments, the processor 116 may be configured to execute the MLA 140 instead of the detection model 214 and the superfact model 216. In these embodiments, the MLA 140 may be implemented as a given I2ICNN model configured to receive an input as a combination of the satellite data 202 for time t, the GFS data 204 for time t, the additional data 206 (e.g., stationary features) at time t, the user report data 208 for time t−1, the radar data 210 for time t, and the ECMWF data 212 for time t.

In these embodiments, the MLA 140 may acquire as input an image of size H×W×C_1, where H and W are the height and width, respectively, of a selected geographical area, and C is a number of channels corresponding to a set of pre-determined features for the MLA 140. The MLA 140 may generate an output image of size H×W with a pixel-by-pixel binary mask indicative of a predication regarding whether or not precipitation occurs in sub-regions of the geographical area covered by the respective pixels of the output image.

### Nowcasting Predictions Based on UGC Training

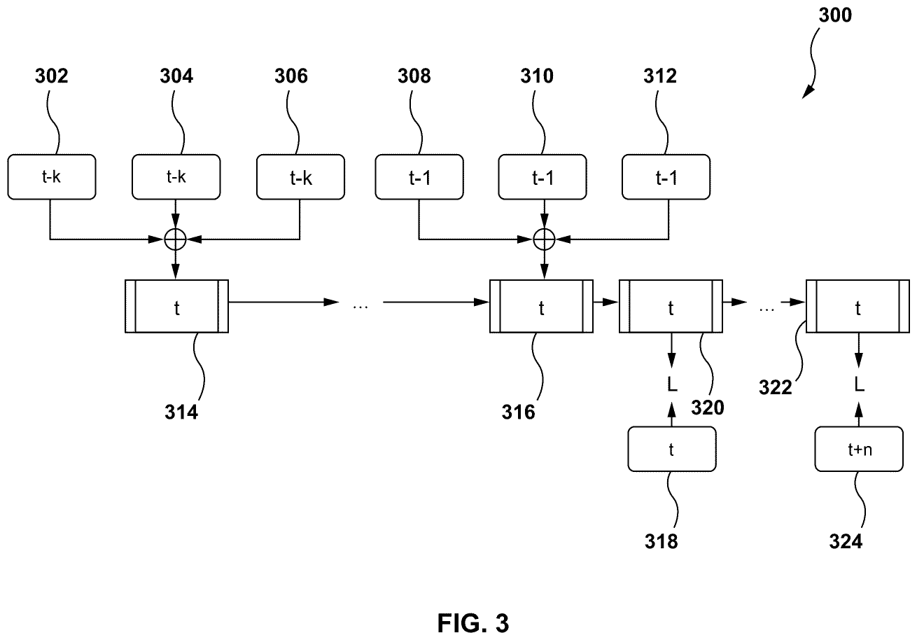

With reference to FIG. 3, there is depicted a schematic representation of a data flow used by the processor 116 during a training phase of an MLA 150 for precipitation predictions for n upcoming hours, also referred to as “nowcasting” predictions. The MLA 150 may be implemented as an I2I model with at least one of an RRN-based architecture, LSTM-based architecture, and transformer-based architecture.

More particularly, the MLA 150 is illustrated in FIG. 3 in an “unrolled network” representation where states 314, 316, 320, and 322 are sequential states of the MLA 150 with data transmitted from one state to the next. As it will become apparent from the description herein further below, the MLA 150 can be said to be in a data acquisition phase from the state 314 to the state 316. It can also be said that the MLA 150 is in a training phase from the state 318 to 322.

The processor 116 may be configured to provide the MLA 150 with an input based on a combination of user report data 302 for time t−k, superfact data 304 for time t−k, radar data 306 for time t−k. In some embodiments, the superfact data 304 may be an output of the superfact model 216 in FIG. 2 for time t−k. In other embodiments, the superfact data 304 may be an output of the MLA 140 for time t−k. The MLA 150 in the state 314 may generate an intermediate output based on the combination of the user report data 302 for time t−k, superfact data 304 for time t−k, and radar data 306 for time t−k, and keep in “memory” to be used by the MLA 150 in a next state therefor. In some implementations, the MLA 150 may receive as input images of size IN_LEN×H×W×C_1 and is configured to generate output images with a dimension of OUT_LEN×H×W×C_2.

Similarly, the processor 116 may be configured to provide the MLA 150 with an input based on a combination of user report data 308 for time t−1, superfact data 310 for time t−1, radar data 312 for time t−1. In some embodiments, the superfact data 310 may be an output of the superfact model 216 in FIG. 2 for time t−1. In other embodiments, the superfact data 304 may be an output of the MLA 140 for time t−1. The processor 116 may generate an intermediate output based on the combination of at least one previous intermediate output (e.g., t−2), user report data 308 for time t−1, superfact data 310 for time t−1, radar data 312 for time t−1.

In some implementations, during the data acquisition phase, the MLA 150 may be provided with input data for a time interval of 40 min (e.g., from t−k to t), with an input timestep of 10 min (e.g., interval of time between t and t−1).

Following the acquisition phase, the MLA 150 is configured to generate output data representative of whether forecast for a future time interval with an output timestep. In some implementations, during the training phase, the MLA 150 may generate output data for a future time interval of 2 hours (e.g., from t to t+n), with an input time step of 10 min (e.g., time interval between t and t+1).

As seen in FIG. 3, the MLA 150 in the state 320 is configured to generate output data for time t. Similarly, the MLA 150 is configured to generate output data for a series of future timesteps in the future time interval. For example, the MLA 150 in the state 322 is configured to generate output data for time t+n.

In some embodiments, the processor 116 may be configured to train the MLA 150 using a loss value determined based on a comparison of the output data generated by the MLA 150 for time t, with superfact data generated by the superfact model 216 (or the MLA 140) for time t. Also, the processor 116 may also be configured to train the MLA 150 using on a loss value determined based on a comparison of the output data generated by the MLA 150 for time t+n, with superfact data generated by the superfact model 216 (or the MLA 140) for time t+n.

In further embodiments, it is contemplated that in addition to employing superfact data generated by the superfact model 216 (or the MLA 140) for respective future time steps as ground-truth data during training of the MLA 150, the processor 116 may employ historical user report data for the respective future time steps as ground-truth data for training the MLA 150. As such, the processor 116 may be configured to generate more than one loss value for a respective future time step, including a first loss value based on a comparison of the output data of the corresponding future time step with the superfact data of the corresponding future time step, and a second loss value based on a comparison of the output data of the corresponding future time step with the historical user report data of the corresponding future time step.

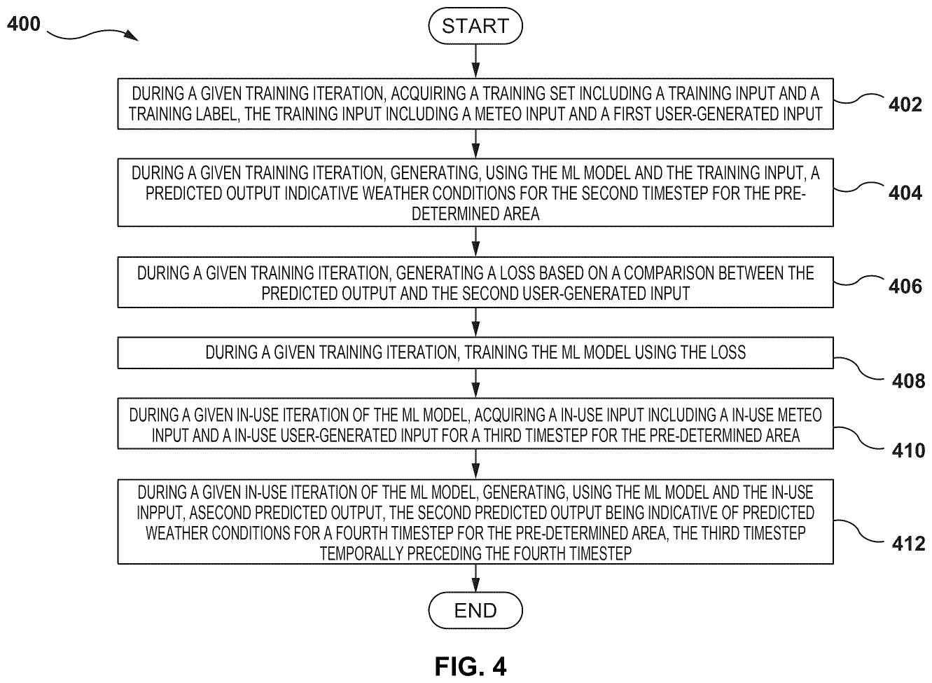

In some embodiments of the present technology, the processor 116 may be configured to execute a computer implemented method 400, the scheme-block representation of which is illustrated in FIG. 4. It should be noted that at least some of the steps of the method 400 may be executed by a same processing device. It is contemplated however that the steps of the method 400 may be executed on a single processing device and/or in a distributed manner of over multiple processing devices, without departing from the scope of the present technology.

### STEP 402: During a Given Training Iteration, Acquiring a Training Set Including a Training Input and a Training Label, the Training Input Including a Meteorological Input and a First User-Generated Input

The method 400 begins at step 402 with the processor 116 configured to, during a given training iteration, acquire a training set including a training input and a training label. The training input includes a meteorological input and a first user-generated input.

It should be noted that the meteorological input is indicative of weather conditions measured by the meteo-sources for a second timestep for a pre-determined area. For example, with reference to FIG. 2, the meteorological input may include satellite data 202 for time t, GFS data 204 for time t, the additional data 206 for time t, the radar data 210 for time t, and the ECMWF data 212 for time t.

It should also be noted that the first user-generated input is indicative weather conditions provided from the user devices at a first timestep for the pre-determined area. For example, in FIG. 2, the user-generated input may include the user report data 208 for time t−1. The first timestep temporally precedes the second timestep. For example, in FIG. 2, time t−1 precedes time t.

The training label includes a second user-generated input indicative of weather conditions provided from the user devices at the second timestep for the pre-determined area. For example, in FIG. 2, the second user-generated input includes user report data 218 for time t. It should be noted that the user report data 218 may be used as ground-truth data for training a given MLA.

### STEP 404: During a Given Training Iteration, Generating, Using the ML Model and the Training Input, a Predicted Output Indicative of Predicted Weather Conditions for the Second Timestep for the Pre-Determined Area

The method 400 continues to step 404 with the processor 116 configured to, during a given training iteration, generate a predicted output using an ML model and the training input.

In some embodiments, the ML model may be single I2ICNN such as the MLA 140. In other embodiments, the ML model may include more than one ML models, such as the detection model 214 and the superfact model 216 in FIG. 2. In some embodiments, the first ML model may be a UNet-based model. In additional embodiments, the second ML model may be a Catboost-based model.

It should be noted that the predicted output generated by the ML model for the training input is indicative of predicted weather conditions for the second timestep for the pre-determined area. In one embodiment, the predicted output may be the output of the superfact model 216. Alternatively, the predicted output may be the output of the MLA 140 for the training input.

### STEP 406: During a Given Training Iteration, Generating a Loss Based on a Comparison Between the Predicted Output and the Second User-Generated Input

The method 400 continues to step 406 with the processor 116 configured to, during a given training iteration, generate a loss based on a comparison between the predicted output (previous step) and the second user-generated input (training label).

In some embodiments where the ML model is a single I2ICNN, such as the MLA 140, for example, the processor 116 may further generate a second loss based on a comparison of an intermediary output of the I2ICNN with a radar input (e.g., the radar data 210 for time t). The radar input is indicative of weather conditions measured by a radar source for the second timestep for the pre-determined area.

In other embodiments, where the ML model includes a first ML model and a second ML model, such as the detection model 214 and the superfact model 216. In these embodiments, the processor 116 may also be configured to generating, using the detection model 214 and the training input, an intermediary output indicative of predicted weather conditions for the second timestep for the pre-determined area. For example, the intermediary output may include an intermediary output image generated by the detection model 214 and a first mask. The first mask is indicative of a likelihood of precipitation for corresponding pixels of the intermediary output image. In these embodiments, the processor 115 may also generate using the superfact model 216 the predicted output based on a combination of the training input and the intermediary output generated by the detection model 214. The predicted output so-generated by the superfact model 216 may include an output image and a binary mask (with 0 and 1 values, as opposed to values on a spectrum such as the values of the first mask of the intermediary output of the detection model 214). The binary mask is indicative of precipitation presence (whether there is precipitation, or not) for corresponding pixels of the output image.

### STEP 408: During a Given Training Iteration, Training the ML Model Using the Loss

The method 400 continues to step 408 with the processor 116 configured to, during a given training iteration, train the ML model using the loss. Broadly, the processor 116 may train the I2ICNN model using a supervised learning technique, where the I2I model is trained on pairs of input-output images. In those embodiments where the processor 116 generates a first loss and a second loss (one based on a comparison with user-generated data and the other one based on a comparison with radar data), the processor 116 may generating a combined loss based on the first loss and a second loss, and train the single I2ICNN model based on the combined loss.

In those embodiments where the ML model includes the first ML model and the second ML model, the processor 116 may train the first ML model using a loss generated based on a comparison with the radar data (the radar data 210 for time t can be used as ground-truth data for training the detection model 214). In those embodiments where the ML model includes the first ML model and the second ML model, the processor 116 may train the second ML model using a loss generated based on a comparison with the user-generated data (the user-generated data 218 for time t can be used as ground-truth data for training the superfact model 216).

STEP 410: During a Given in-Use Iteration of the ML Model, Acquiring an in-Use Input Including an in-Use Meteorological Input and a Current User-Generated Input for a Third Timestep for the Pre-Determined Area

The method 400 continues to step 410 with the processor 116 configured to, during a given in-use iteration of the ML model, acquire a current input including a current meteorological input and a current user-generated input for a third timestep for the pre-determined area. For example, following the training iteration illustrated in FIG. 2, the processor 116 may be configured to acquire satellite data for time t+1, GFS data for t+1, additional features for t+1, user report data for t, radar data for t+1, and EMCWF data for time t+1.

It is contemplated that the processor 116 may be configured to, during a given in-use phase of the ML model, acquire a series of in-use inputs each including a respective current meteorological input and a respective current user-generated input for a corresponding in-use timestep for the pre-determined area. For example, the processor 116 may be configured to acquire for a given one of a series of in-use inputs respective satellite data for a corresponding time, respective GFS data for the corresponding time, respective additional features for the corresponding time, respective user report data for a corresponding time (and/or a prediction output of the ML model for a previous in-use iteration), respective radar data for the corresponding time, and EMCWF data for the corresponding time.

STEP 412: During a Given in-Use Iteration of the ML Model, Generating, Using the ML Model and the in-Use Input, a Second Predicted Output, the Second Predicted Output being Indicative of Predicted Weather Conditions for a Fourth Timestep for the Pre-Determined Area, the Third Timestep Temporally Preceding the Fourth Timestep

The method 400 continues to step 412 with the processor 116 configured to, during a given in-use iteration of the ML model, generating by the ML model using the in-use input (previous step), a second predicted output. The second predicted output being indicative of predicted weather conditions for a fourth timestep for the pre-determined area, and where the third timestep temporally preceding the fourth timestep.

For example, based on the in-use input comprising the satellite data for time t+1, GFS data for t+1, the additional features for t+1, the user report data for t, the radar data for t+1, and the EMCWF data for time t+1, the MLA 140 (and/or the combination of the detection model 214 and the superfact model 216) may generate an in-use predicted output for time t+1.

Developers of the present technology have realized that training an ML model using at least UGC data as ground-truth, may allow predicting outputs that are more reliable than outputs generated by an ML model using solely radar data as ground-truth for training.

Additionally, developers have realized that automatic generation of UGC data may be advantageous for nowcasting solutions. In at least some embodiments, the processor 116 may be configured to employ one or more ML models in order to generate a sequence of predicted outputs. The sequence of predicted outputs may be further used by the processor 116 in order to train one or more nowcasting ML models.

It should be noted that a number and frequency of predicted outputs to be generated by a given ML model during a respective in-use phase thereof may depend on inter alia how a given nowcasting ML model is implemented. For example, the given nowcasting ML model may be configured to acquire data samples at a first frequency (e.g., every 10 min) within an acquisition window with a first time length (e.g., 40 min). In these embodiments, the processor 116 may be configured to execute the ML model for generating predicted outputs for timestamps at the first frequency, and for at least the first time length.

Developers of the present technology have also realized that the ML model may be used to generate the sequence of predicted outputs of the ML model in an automatic manner. It should be noted that automatic data generation may allow for the rapid creation of large datasets without manual effort. This is especially advantageous when dealing with complex ML models that require large amounts of diverse data for effective training.

Developers have realized that automating generation of UGC data enables the generation of more diverse input data for the nowcasting ML model, capturing a wide range of scenarios and variations. In some cases, this may improve the nowcasting ML model's generalization capabilities by exposing it to a more comprehensive set of situations that may be encountered in real-time applications.

Developers have also realized that current UGC data may not always be available or complete for a given geographic region. Automated UGC data generation may allow to compensate for unavailability or lack of current UGC data when the nowcasting ML model is used in real-time applications.

Developers of the present technology have also realized that the sequence of predicted outputs of the ML model may be used both as part of the training input for the nowcasting ML model and as part of the training label for the nowcasting ML model. As such, the automatic generation of the sequence of predicted outputs of the ML model may be leveraged for both generating training inputs and training labels for training the nowcasting ML model.

With reference to FIG. 3, the processor 116 may be configured to use the MLA 140 (and/or the superfact model 216) to generate a series of predicted outputs including: the superfact data 304 for t−k, . . . , the superfact data 310 for t−1, the superfact data 318 for time t, . . . , the superfact data 324 for t+n. The processor 116 may be configured to store the series of predicted outputs for further use by the nowcasting ML model (MLA 150).

In some embodiments, the processor 116 may be configured to generate using the ML model the superfact data 310 for time t−1 based on an in-use input for time t−1 (including meteorological data for time t−1 as well as UGC data for time t−2 and/or superfact data generated for time t−2). In these embodiments, the processor 116 may be configured to generate using the ML model the superfact data 318 for time t based on an other in-use input for time t (including meteorological data for time t as well as UGC data for time t−1 and/or superfact data 310 for time t−1).

In some embodiments, the processor 116 may provide the nowcasting ML model 150 with a first nowcasting input for time t−1 for the pre-determined area the first nowcasting input includes, the predicted output from the ML model for time t−1 (being the superfact data t−1), the radar input 312 for time t−1, and the user-generated input 308 for time t−1 (at least optionally). The nowcasting ML model 150 may generate a nowcasting output indicative of predicted weather conditions for time t for the pre-determined area. The processor 116 may generate a nowcasting loss based on a comparison between the nowcasting output for time t and the third predicted output from the ML model for time t (being the superfact data 318 for time t). The processor 116 may be configured to train the nowcasting ML model 150 using the nowcasting loss.

In some embodiments, the processor 116 may be configured to generate a series of losses for a series of future predictions made by the nowcasting ML model 150 (for example, from t to t+n). The processor 116 may be configured to train the nowcasting ML model 150 based on a combination of the series of loss values. At a next training iteration however, it should be noted that the superfact data 318 for time t may be used as part of a new nowcasting input, and superfact data for time t+n+1 may be used as part of the new nowcasting label.

Modifications and improvements to the above-described implementations of the present technology may become apparent to those skilled in the art. The foregoing description is illustrative only and is not intended to be in any way limiting. The scope of the present technology is therefore intended to be limited solely by the scope of the appended clauses.

1. A method of training a machine learning (ML) model for generating predicted weather conditions, the method being executable by a processor, the processor being communicatively coupled with meteo-sources and user devices, the method comprising:
during a given training iteration:
acquiring a training set including a training input and a training label,
the training input including a meteorological input and a first user-generated input,
the meteorological input being indicative of weather conditions measured by the meteo-sources for a second timestep for a pre-determined area,
the first user-generated input being indicative weather conditions provided from the user devices at a first timestep for the pre-determined area, the first timestep temporally preceding the second timestep,
the training label including second user-generated input indicative of weather conditions provided from the user devices at the second timestep for the pre-determined area;
generating, using the ML model and the training input, a predicted output indicative of predicted weather conditions for the second timestep for the pre-determined area;
generating a loss based on a comparison between the predicted output and the second user-generated input;
training the ML model using the loss;
during a given in-use iteration of the ML model:
acquiring an in-use input including an in-use meteorological input and an in-use user-generated input for a third timestep for the pre-determined area;
generating, a second predicted output using the ML model and the in-use input,
the second predicted output being indicative of predicted weather conditions for a fourth timestep for the pre-determined area, the third timestep temporally preceding the fourth timestep.

2. The method of claim 1, wherein the ML model is an Image-to-Image Convolutional Neural Network (I2ICNN).

3. The method of claim 2, wherein the loss is a first loss, the method further comprising:
generating a second loss based on a comparison of an intermediary output of the I2ICNN with a radar input,
the radar input being indicative of weather conditions measured by a radar source for the second timestep for the pre-determined area;
wherein the training the ML model comprises:
training the ML model using a combination of the first loss and the second loss.

4. The method of claim 1, wherein the ML model comprises a first ML model and a second ML model, the generating the predicted output includes:
generating an intermediary output using the first ML model and the training input, the intermediary output indicative of predicted weather conditions for the second timestep for the pre-determined area,
the intermediary output including an intermediary output image and a first mask, the first mask being indicative of a likelihood of precipitation for corresponding pixels of the intermediary output image;
generating the predicted output using the second ML model, the training input and the intermediary output,
the predicted output including an output image and a binary mask, the binary mask being indicative of whether or not the precipitation is present for corresponding pixels of the output image.

5. The method of claim 4, wherein the loss is a first loss, and wherein the method further comprises:
generating a second loss based on a comparison between the intermediary output and a radar input for the second time step for the pre-determined area,
the radar input being indicative of weather conditions measured by a radar source for the second timestep for the pre-determined area;
the training the ML model comprises:
training the first ML model using the second loss, and
training the second ML model using the first loss.

6. The method of claim 4, wherein the first ML model is a UNet-based model, and the second ML model is a Catboost-based model.

7. The method of claim 1, wherein the method further comprises:
acquiring a second in-use input including a second in-use meteorological input and a second predicted output generated by the ML model;
generating a third predicted output using the ML model and the second in-use input,
the third predicted output being indicative of predicted weather conditions for a fifth timestep for the pre-determined area, the fourth timestep temporally preceding the fifth future timestep.

8. The method of claim 7, wherein the method further comprises:
providing, to a nowcasting ML model, a nowcasting training input for the fourth timestep for the pre-determined area, the nowcasting input including the second predicted output from the ML model;
generating, by the nowcasting ML model using the nowcasting training input, a nowcasting output indicative of predicted weather conditions for the fifth timestep for the pre-determined area;
generating a nowcasting loss based on a comparison between the nowcasting output for the fifth timestep and the third predicted output from the ML model for the fifth timestep;
training the nowcasting ML model using the nowcasting loss.

9. The method of claim 8, wherein the nowcasting input further includes a radar input indicative of weather conditions measured by a radar source for the fourth timestep for the pre-determined area, and a third user-generated input for the fourth timestep.

10. The method of claim 8, wherein the nowcasting ML model is at least one of a LSTM-based model and a Transformer-based model.

11. A method of training a nowcasting machine learning (ML) model for generating predicted weather conditions, the method being executable by a processor, the method comprising:
generating a series of predicted outputs using a first ML model,
a given one from the series of predicted outputs being indicative of predicted user-generated data for a corresponding timestep for the pre-determined area;
during a first training iteration:
generating a training set using the series of predicted outputs for the nowcasting ML model, the training set including a training input and a training label,
the training input having the given one from the series of predicted outputs,
the training label having a next one from the series of predicted outputs, the next one from the series of predicted outputs being indicative of predicted user-generated data for a next timestep for the pre-determined area, the corresponding timestep temporally proceeding the next timestep;
training the nowcasting ML model using the training set;
during a second training iteration:
generating a second training set using the series of predicted outputs for the nowcasting ML model, the training set including a second training input and a second training label,
the second training input having the next one from the series of predicted outputs,
the training label having an additional one from the series of predicted outputs, the additional one from the series of predicted outputs being indicative of predicted user-generated data for an additional timestep for the pre-determined area, the next timestep temporally proceeding the additional timestep;
training the nowcasting ML model using the second training set.

12. A processor for training a machine learning (ML) model for generating predicted weather conditions, the processor being communicatively coupled with meteo-sources and user devices, the processor being configured to:
during a given training iteration:
acquire a training set including a training input and a training label,
the training input including a meteorological input and a first user-generated input,
the meteorological input being indicative of weather conditions measured by the meteo-sources for a second timestep for a pre-determined area,
the first user-generated input being indicative weather conditions provided from the user devices at a first timestep for the pre-determined area, the first timestep temporally preceding the second timestep,
the training label including second user-generated input indicative of weather conditions provided from the user devices at the second timestep for the pre-determined area;
generate, using the ML model and the training input, a predicted output indicative of predicted weather conditions for the second timestep for the pre-determined area;
generate a loss based on a comparison between the predicted output and the second user-generated input;
train the ML model using the loss;
during a given in-use iteration of the ML model:
acquire an in-use input including an in-use meteorological input and an in-use user-generated input for a third timestep for the pre-determined area;
generate, a second predicted output using the ML model and the in-use input,
the second predicted output being indicative of predicted weather conditions for a fourth timestep for the pre-determined area, the third timestep temporally preceding the fourth timestep.

13. The processor of claim 12, wherein the ML model is an Image-to-Image Convolutional Neural Network (I2ICNN).

14. The processor of claim 13, wherein the loss is a first loss, the processor being further configured to:
generate a second loss based on a comparison of an intermediary output of the I2ICNN with a radar input,
the radar input being indicative of weather conditions measured by a radar source for the second timestep for the pre-determined area;
wherein to train the ML model the processor is configured to:
train the ML model using a combination of the first loss and the second loss.

15. The processor of claim 12, wherein the ML model comprises a first ML model and a second ML model, to generate the predicted output including the processor configured to:
generate an intermediary output using the first ML model and the training input, the intermediary output indicative of predicted weather conditions for the second timestep for the pre-determined area,
the intermediary output including an intermediary output image and a first mask, the first mask being indicative of a likelihood of precipitation for corresponding pixels of the intermediary output image;
generate the predicted output using the second ML model, the training input and the intermediary output,
the predicted output including an output image and a binary mask, the binary mask being indicative of whether or not the precipitation is present for corresponding pixels of the output image.

16. The processor of claim 15, wherein the loss is a first loss, and wherein the processor is further configured to:
generate a second loss based on a comparison between the intermediary output and a radar input for the second time step for the pre-determined area,
the radar input being indicative of weather conditions measured by a radar source for the second timestep for the pre-determined area;
to train the ML model comprises the processor configured to:
train the first ML model using the second loss, and
train the second ML model using the first loss.

17. The processor of claim 15, wherein the first ML model is a UNet-based model, and the second ML model is a Catboost-based model.

18. The processor of claim 12, wherein the processor is further configured to:
acquire a second in-use input including a second in-use meteorological input and a second predicted output generated by the ML model;
generate a third predicted output using the ML model and the second in-use input,
the third predicted output being indicative of predicted weather conditions for a fifth timestep for the pre-determined area, the fourth timestep temporally preceding the fifth future timestep.

19. The processor of claim 18, wherein the processor is further configured to:
provide, to a nowcasting ML model, a nowcasting training input for the fourth timestep for the pre-determined area, the nowcasting input including the second predicted output from the ML model;
generate, by the nowcasting ML model using the nowcasting training input, a nowcasting output indicative of predicted weather conditions for the fifth timestep for the pre-determined area;
generate a nowcasting loss based on a comparison between the nowcasting output for the fifth timestep and the third predicted output from the ML model for the fifth timestep;
train the nowcasting ML model using the nowcasting loss.

20. The method of claim 8, wherein the nowcasting ML model is at least one of a LSTM-based model and a Transformer-based model.
